(19) United States
(12) Patent Application Publication
(10) Pub. No.: US 2015/0181659 A1
(43) Pub. Date: Jun. 25, 2015

(54) LED DRIVING DEVICE

(71) Applicant: Seoul Semiconductor Co., Ltd., Ansan-si (KR)

(72) Inventors: Hyun Gu Kang, Ansan-si (KR); Hye Man Jung, Ansan-si (KR)

(73) Assignee: Seoul Semiconductor Co., Ltd., Ansan-si (KR)

(21) Appl. No.: 14/365,376

(22) PCT Filed: Dec. 14, 2012
(86) PCT No.: PCT/KR2012/010948

§ 371 Date: Oct. 1, 2014

(30) Foreign Application Priority Data
Dec. 16, 2011 (KR) 10-2011-0136740
Dec. 14, 2012 (KR) 10-2012-0146675

(51) Int. Cl. H05B 33/08

(52) U.S. Cl. CPC H05B 33/083; H05B 33/0809; H05B 33/0845

(57) ABSTRACT

Disclosed is an LED driving apparatus capable of removing a non-light-emitting section and extending device life span by adding an optical power compensation circuit to a driving circuit of a multi-stage current driving mode. The design is more efficient with respect to a forward voltage of an LED array driven by the multi-stage current driving circuit and the unique operational characteristics of the optical power compensation circuit. The LED driving apparatus drives a plurality of LED groups and includes a rectification unit for rectifying an AC voltage to generate a ripple voltage at an output, an optical power compensation unit to supply a pre-stored compensation voltage to the LED array when the ripple voltage is less than a minimum forward voltage in the plurality of LED groups, and a constant current driving unit connected the plurality of LED groups to sequentially drive each LED group with a constant current.

This application is the National Stage Entry of International Application PCT/KR2012/010948, filed on Dec. 14, 2012, and claims priority from and the benefit of Korean Patent Application No. 10-2011-0136740, filed Dec. 16, 2011 and Korean Patent Application No. 10-2012-0146675, filed Dec. 14, 2012, all of which are incorporated herein by reference for all purposes as if fully set forth herein.

### BACKGROUND

1. Field

The present invention relates to a light emitting diode (LED) driving device, and more particularly, to an LED driving device in which an optical power compensation circuit is added to a multistage current driving circuit and unique operational characteristics of the optical power compensation circuit are taken into account to have an effective design in consideration of efficiency of forward voltage of an LED array driven by the multistage current driving circuit, thereby removing a non-light-emitting section and extending the lifespan of an apparatus.

2. Discussion of the Background

Light emitting diodes (LEDs) are a kind of photoelectric device. Each LED has a light emitting structure composed of a plurality of semiconductor layers including a p-n junction, and converts electric energy into optical energy. LEDs can emit light of high brightness with low voltage as compared with other devices used as a light source, thereby providing an advantage of high energy efficiency. In particular, when a light emitting structure is formed of gallium nitride (GaN), LEDs may be designed to emit light having a wavelength selected in a wide region from infrared to ultraviolet wavelengths. Advantageously, LEDs are variously applicable to backlight units of liquid crystal displays, electronic display boards, display devices, home appliances, and various devices, and does not need toxic materials such as arsenic (As), mercury (Hg), etc., thereby attracting attention as a next generation light source.

In addition, LEDs can be driven by direct current (DC) voltage converted by a converter from commercial AC power. For example, in the simplest form of a conventional LED driving circuit using AC power, DC voltage output from a rectification circuit such as a bridge diode or the like is used to drive an LED device. Most of such LED driving circuits generate a predetermined phase difference between driving voltage and current applied to the LED device. Therefore, the conventional LED driving circuit has a problem that its power factor, total harmonic distortion, and similar electric characteristics do not satisfy standards for products such as LED luminaires (i.e., LED light fixtures).

To resolve this problem, there has been proposed a method of using a multi-stage driving switch to supply driving current having a stepped or square waveform to a plurality of LED groups and sequentially drive the plurality of LED groups. The technique of sequentially driving the plurality of LED groups through the multi-stage driving switch is disclosed in U.S. Pat. No. 7,081,722, etc. In addition, the present applicant, Seoul Semiconductor Co., Ltd., released a product named Acrich that employs a multi-stage driving switch to sequentially drive a plurality of LED groups, in November 2006.

FIG. 1 is a view of an exemplary configuration of a conventional sequential driving light emitting diode (LED) driving device, and FIG. 2 is a view of waveforms of alternating current (AC) and AC voltage of AC power supplied to the LED driving device of FIG. 1.

As shown in FIG. 1, a conventional LED driving device includes a bridge diode 3, switches 5 (SW1, SW2, SW3, and SW4) and a switch controller 6, and rectifies AC power 2 through the bridge diode 3 without any separate converter for converting the AC power into relatively constant DC power, thereby generating ripple voltage and supplying the ripple voltage to an LED array 4. The LED array 4 includes a plurality of LED groups, each of which includes at least one LED device.

Such a conventional LED driving device controls the switch 5 connected to each LED group through the switch controller 6 such that the plurality of LED groups can sequentially emit light in accordance with waveforms of the ripple voltage varying over time. The plurality of LED groups connected to each other in series has a forward voltage Vf stepwise increasing with increasing number of LED groups from an input terminal thereof

The foregoing LED driving device should be manufactured to have electric characteristics such as a power factor and total harmonic distortion that satisfy standards for products (application). That is, the conventional LED driving device controls the plurality of LED groups to sequentially emit light such that the waveform of the driving current can follow the driving voltage in a ripple voltage form in order to satisfy the standards required of the product. In that case, phases of AC voltage and AC current become equal at the side of the commercial AC power supplied to the LED driving device, as shown in FIG. 2, whereby the conventional LED driving device and products using the same have an advantage of improving electric characteristics, such as power factor, total harmonic distortion, and the like. In addition, the conventional LED driving device is set to allow the LED groups to be turned on early while delaying turn-off of the LED group emitting light, thereby improving efficiency of using light for one cycle.

However, there is a limit to the type or kind of LED groups applicable to such a LED driving device of the multistage current driving mode, and it is difficult to configure the LED driving device and optimal sets of the LED driving device since forward voltage of a LED group selected from the plurality of limited LED groups is already fixed. That is, in the conventional LED driving device of the multistage current driving mode, adjusting or setting the forward voltage of the plural LED groups in an efficient manner is difficult.

Further, in the foregoing LED driving device with a multistage current driving mode, a non-light-emitting section is generated when driving voltage is lower than forward voltage of the first LED group among the plural LED groups in a section, in which the driving voltage or driving current passes to the next cycle. Such a section with no light output (non-light-emitting section) causes light flickering.

The above information disclosed in this Background section is only for enhancement of understanding of the background of the inventive concept, and, therefore, it may contain information that does not form the prior art that is already known in this country to a person of ordinary skill in the art.

### SUMMARY

The present invention has been conceived to solve such problems in the art, and it is an aspect of the present invention to provide a light emitting diode (LED) driving device, in which an optical power compensation circuit is added to a multistage current driving circuit, and unique operational characteristics of the optical power compensation circuit are taken into account to have an effective design in consideration of efficiency of forward voltage of an LED array driven by the multistage current driving circuit, thereby removing a non-light-emitting section and extending the lifespan of an apparatus.

In accordance with one aspect of the present invention, a light emitting diode (LED) driving device connected to an LED array including a plurality of LED groups and sequentially driving the plurality of LED groups includes: a rectification unit rectifying alternating current (AC) voltage to generate a ripple voltage; an optical power compensation unit connected to an output terminal of the rectification unit and supplying a pre-stored compensation voltage to the LED array in a section in which the ripple voltage is smaller than a minimum forward voltage in the plurality of LED groups; and a constant current drive unit connected to each LED group of the plurality of LED groups and sequentially driving each LED group with a constant current.

In the LED driving device according to one embodiment of the invention, the optical power compensation unit includes a first capacitor, a second capacitor, a first diode, a second diode, and a third diode, wherein the first capacitor includes a first terminal connected to an output terminal at a high potential side of the rectification unit, and a second terminal connected to an anode of the first diode; the second capacitor includes a first terminal connected to a cathode of the first diode and a second terminal connected to an output terminal at a low potential side of the rectification unit; the second diode includes an anode connected to the output terminal at the low potential side of the rectification unit and a cathode connected in common to the second terminal of the first capacitor and the anode of the first diode; and the third diode includes an anode connected in common to the first terminal of the second capacitor and the cathode of the first diode, and a cathode connected to the output terminal at the high potential side of the rectification unit.

In the LED driving device according to another embodiment of the invention, the optical power compensation unit further includes a resistor connected in series between the first capacitor and the second capacitor.

In the LED driving device according to a further embodiment of the invention, the optical power compensation unit charges each of the first and second capacitors with voltage higher than the minimum forward voltage.

In the LED driving device according to yet another embodiment of the invention, the rectification unit applies the ripple voltage having a peak voltage higher than the forward voltage of the LED array to the optical power compensation unit and the LED array.

In the LED driving device according to yet another embodiment of the invention, the constant current drive unit drives at least one LED group of the LED array to continuously emit light with the compensation voltage.

In accordance with another aspect of the present invention, a light emitting diode (LED) driving device includes: a rectification unit rectifying alternating current (AC) voltage to generate a rectified voltage; a light emitter including at least one light emitting diode connected to an output terminal of the rectification unit; and an optical power compensation unit connected between the rectification unit and the light emitter, and supplying electric current to the light emitter corresponding to a pre-stored rectified voltage in a section in which the rectified voltage is lower than a forward voltage of the light emitting diode.

The LED driving device according to one embodiment of the invention further includes a switch unit including at least one switch connected to a cathode of the light emitting diode.

The LED driving device according to another embodiment of the invention further includes a switch controller detecting electric current flowing in the switch and controlling the switch to be short-circuited or opened depending upon amplitudes of the detected electric current.

In the LED driving device according to a further embodiment of the invention, the optical power compensation unit performs charging with a constant voltage in a section in which the rectified voltage is higher than or equal to a preset first voltage, and discharges the charged voltage in a section in which the rectified voltage is lower than the first voltage.

In the LED driving device according to yet another embodiment of the invention, the optical power compensation unit includes: a first capacitor and a second capacitor connected in series between an output terminal at a high potential side of the rectification unit and an output terminal at a low potential side of the rectification unit; a first diode forward connected between the first capacitor and the second capacitor; a second diode including a cathode connected to the first capacitor and an anode connected to the output terminal at the low potential side of the rectification unit, and a third diode including an anode connected to a connection node between the first diode and the second capacitor, and a cathode connected to the output terminal at the high potential side of the rectification unit.

In the LED driving device according to yet another embodiment of the invention, the first capacitor and the second capacitor are charged with a voltage obtained by dividing a peak voltage of the rectified voltage by the number of stages for the capacitor.

In the LED driving device according to yet another embodiment of the invention, the optical power compensation unit charges the first capacitor and the second capacitor with voltage when the rectified voltage is higher than or equal to the first voltage determined by the number of stages for the capacitor involved in the optical power compensation unit, and discharges the voltage charged in the first and second capacitors to the light emitter when driving voltage is lower than the first voltage.

In the LED driving device according to yet another embodiment of the invention, the optical power compensation unit further includes a resistor including one end connected to the cathode of the second diode, and the other end connected to a connection node between the second capacitor and the third diode.

In the LED driving device according to yet another embodiment of the invention, the first voltage is higher than the forward voltage of the light emitting diode.

With the foregoing configurations, the light emitting diode (LED) driving device according to the present invention includes an optical power compensation circuit such as a valley-fill circuit in a multistage current driving circuit and takes unique operational characteristics of the optical power compensation circuit into account, thereby providing an effect of designing forward voltage of an LED array driven by the multistage current driving circuit of an apparatus in an efficient manner.

In the LED driving device according to embodiments of the invention, the driving device operating an LED array including a plurality of LED groups to sequentially emit light in response to AC power employs a passive component instead of using power converting circuits, such as a converter, a smoothing circuit, etc., thereby enabling elimination of a non-light emitting section while improving quality of a light source.

In the LED driving device according to other embodiments of the invention, the driving device driving an LED array including a plurality of LED groups in a multistage control mode employs the optical power compensation unit and thus eliminates a relatively bulky electrolytic capacitor used in a smoothing circuit or the like, thereby minimizing the size of an apparatus while substantially extending the lifespan of the apparatus, and facilitating application of the LED driving device to luminaires and the like.

Additional aspects will be set forth in the detailed description which follows, and, in part, will be apparent from the disclosure, or may be learned by practice of the inventive concept. The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a view of an exemplary configuration of a conventional light emitting diode (LED) driving device.

FIG. 2 is a view of waveforms of alternating current (AC) and AC voltage of AC power supplied to the LED driving device of FIG. 1.

FIG. 3 is a schematic configuration view of an LED driving device according to one embodiment of the present invention.

FIG. 4 is a waveform view illustrating an operating principle of an optical power compensation unit in the LED driving device of FIG. 3.

FIG. 5 is a view illustrating the operating principle of the optical power compensation unit in the LED driving device of FIG. 3.

FIG. 6 is a timing view illustrating the operating principle of the optical power compensation unit in the LED driving device of FIG. 3.

FIG. 7 is a timing view illustrating operation of an LED driving device according to a comparative example, which does not include the optical power compensation unit.

FIG. 8 is a circuit diagram of an optical power compensation unit that can be employed in an LED driving device according to one embodiment of the present invention.

FIG. 9 is a waveform view illustrating an operating principle of an optical power compensation unit in an LED driving device according to the present invention.

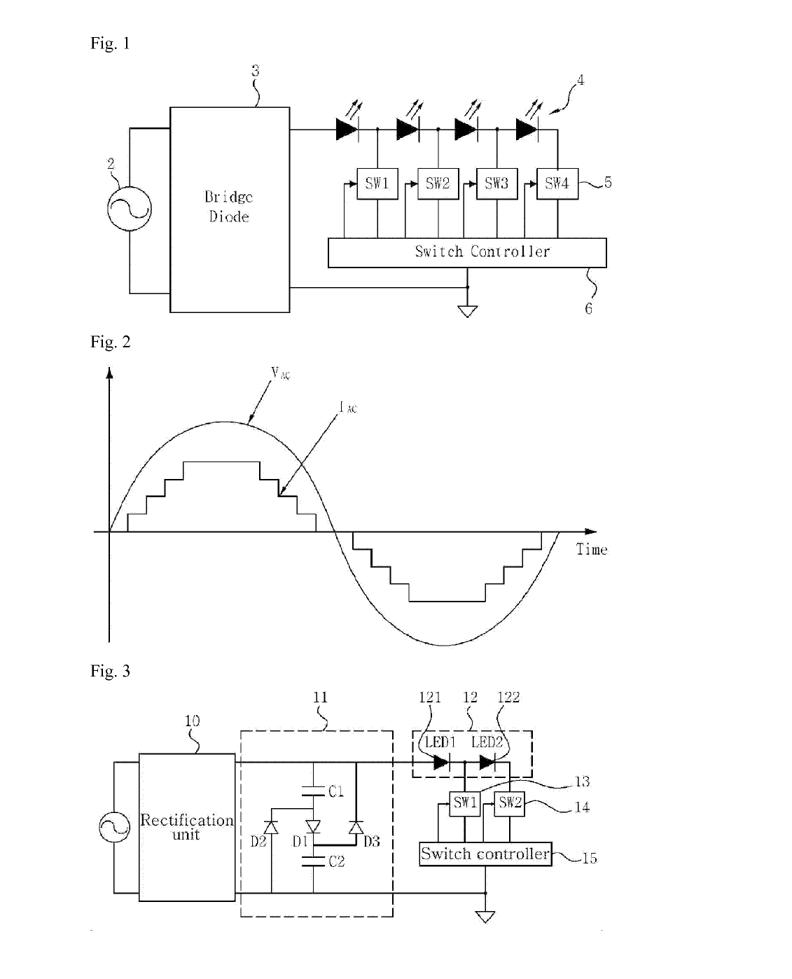

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

Terms and words used in the following description and claims should be interpreted as having a meaning that is consistent with their meaning in the context of the specification and relevant art and should not be interpreted in an idealized or overly formal sense as defined in commonly used dictionaries. In addition, the disclosure in the specification and the configurations shown in the drawings are just exemplary embodiments of the present invention and do not cover all the technical idea of the present invention. Thus, it should be understood that such embodiments may be replaced by various equivalents and modifications at the time point when the present application is filed.

Terms used in the specification are used merely to illustrate certain embodiments and do not limit the present invention. As used in this specification, the singular forms “a”, “an” and “the” are intended to include the plural forms as well, unless context clearly indicates otherwise.

It will be understood that, when an element is referred to as being “connected” to another element, it can be not only “directly connected” to the other element, but also “electrically connected” thereto with intervening elements therebetween. In addition, components unrelated to the description are omitted for clarity in the drawings, and like components will be denoted by like reference numerals throughout the specification.

FIG. 3 is a schematic configuration view of an LED driving device according to one embodiment of the present invention.

Referring to FIG. 3, an LED driving device according to one embodiment of the invention includes a rectification unit 10, an optical power compensation unit 11, a first switch 13, a second switch 14, and a switch controller 15.

The rectification unit 10 rectifies alternating current (AC) power (commercial AC power and the like) to output a voltage having an AC component (ripple voltage). The rectification unit 10 may include any existing rectifying circuits, such as a bridge diode of rectifying full waves of the AC power. Here, the AC power is an input power of the LED driving device and has characteristics of varying amplitude and direction according to reference frequencies.

The optical power compensation unit 11 is charged with the ripple voltage that is output from the rectification unit 10 and has amplitudes varying over time, and supplies a compensation voltage for eliminating a non-light-emitting section to an LED array including first and second LED groups 121 and 122 in a certain section of the ripple voltage.

In this embodiment, the optical power compensation unit 11 includes a first capacitor C1, a second capacitor C2, a first diode D1, a second diode D2, and a third diode D3. Here, the first capacitor C1 includes a first terminal and a second terminal, in which the first terminal is connected to an output terminal at a high potential side of the rectification unit 10 and the second terminal is connected to an anode of the first diode D1. The second capacitor C2 includes a first terminal and a second terminal, in which the first terminal is connected to a cathode of the first diode D1 and the second terminal is connected to an output terminal at a low potential side of the rectification unit 10. The anode of the second diode D2 is connected to the output terminal at the low potential side of the rectification unit, and the cathode of the second diode D2 is connected in common to the second terminal of the first capacitor and the anode of the first diode D1. The anode of the third diode D3 is connected in common to the first terminal of the second capacitor C2 and the cathode of the first diode D1, and the cathode of the third diode D3 is connected to the output terminal at the high potential side of the rectification unit 10.

The first and second capacitors C1 and C2 of the optical power compensation unit 11 may have the same capacitance such that charge and discharge characteristics match. Such a two-stage capacitor circuit has an effect of reducing current peaks of the driving current supplied by the ripple voltage to the LED array. Therefore, the LED array 12 has an effect of improving a power factor and total harmonic distortion.

In addition, the first and second capacitors C1 and C2 of the optical power compensation unit 11 may be realized by ceramic capacitors or the like since they can have a smaller volume and capacitance than existing electrolytic capacitors for smoothing, thereby preventing the lifespan of the LED driving device from being shortened due to the short lifespan of the existing electrolytic capacitors while reducing the size of products employing the LED driving device.

The optical power compensation unit 11 may be provided in the form of a power factor compensation circuit, such as valley-fill, charge-pump, and the like, which is composed of passive components, such as an inductor L, a capacitor C, a resistor R, and the like without any separate control circuit. If the passive power factor compensation circuit is used for the optical power compensation unit 11, it is possible to eliminate the non-light-emitting section while improving power factor and total harmonic distortion. In this embodiment, for convenience of description, a valley-fill power factor compensation circuit will be described as a representative passive power factor compensation circuit by way of example.

The first switch SW1 13 is connected in series to an output terminal of a first LED group 121 to control current flow of the first LED group 121. The second switch SW2 14 is connected in series to an output terminal of the second LED group 122 to control current flow of the first and second LED groups 121, 122 connected in series to each other. The first and second switches 13, 14 are realized by semiconductor switches and may constitute a switch unit including a plurality of switches. The semiconductor switch may include a metal oxide semiconductor field effect transistor (MOSFET), and the like.

The first and second switches 13, 14 represent the plurality of switches. According to one embodiment of the invention, the number of switches may be three, four or more. Further, the first and second LED groups 121, 122 represent a plurality of LED groups. In this embodiment, the number of LED groups may be three or more. The plurality of LED groups corresponds to one LED array 12, and each LED group may be connected to one switch and driven with a constant current by operation of the switch. Further, the LED array 12 may include the plurality of LED groups in which at least two LED groups are connected in series and the same polarities are connected to each other (i.e. connected in parallel). Each LED group includes at least one light emitting diode. The LED array 12 corresponds to a light emitter driven under control of the LED driving device.

The switch controller 15 controls operation of the first and second switches 13, 14. The switch controller 15 detects electric current flowing in each switch and controls operation of each switch such that the first switch 13 can control driving current flowing in the first LED group 121 with a constant current and the second switch 14 can control driving current flowing in the first and second LED groups 121, 122 with a constant current. For example, the switch controller 15 may apply a control signal to a control terminal of the switch such that the current flowing in the switch can be controlled to have a preset level depending upon the driving voltage supplied from the rectification unit 10 and the compensation voltage supplied from the optical power compensation unit 11. The switch controller 15 may be realized by a current regulator.

When the first and second switches 13, 14 are realized by a normally-on semiconductor switch, the switch controller 15 can turn off the first switch to operate the second switch, or can turn off the other switch (e.g., the second switch) to operate the first switch.

The combination of the first switch 13, the second switch 14 and the switch controller 15 may correspond to at least one constant current drive unit for sequentially driving the plurality of LED groups of the LED array 12 with a constant current.

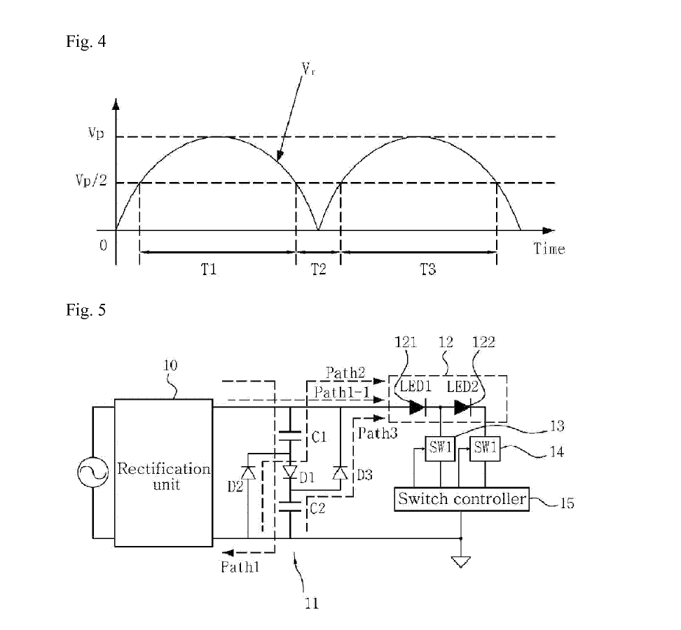

FIG. 4 is a waveform view illustrating an operating principle of an optical power compensation unit in the LED driving device of FIG. 3, and FIG. 5 is a view illustrating the operating principle of the optical power compensation unit in the LED driving device of FIG. 3.

Referring to FIGS. 4 and 5, when a ripple voltage Vr is higher than Vp/2 in a first section T1 and a third section T3 where the ripple voltage Vr is supplied to the LED array 12, the first diode D1 of the optical power compensation unit 11 is turned on to form a first path Path1, and the first capacitor C1 and the second capacitor C2 on the first path is charged with Vp/2. Here, it is assumed that the voltage of the first capacitor C1 is equal to the voltage of the second capacitor C2. The ripple voltage refers to a voltage that is output from the rectification unit 10, has a predetermined peak voltage Vp, and periodically varies in the amplitude of the voltage by AC components over time. Further, the forward voltage of the first diode D1 is ignorable since it is much lower than Vp/2. In addition, if the ripple voltage Vr is higher than Vp/2, the LED array 12 is driven by a constant-current voltage output from the rectification unit 10 through a path Path 1-1 (Mode 1)

In the first mode (Mode 1), efficiency can be expressed as follows.

$$Efficiency ( Mode 1 ) = \frac{{V}_{P}}{( {V}_{LED 1} + {V}_{LED 2} )} \qquad Equation 1$$

In Equation 1, Vp is the peak level of the ripple voltage, V_{LED1} is a driving voltage for the first LED group LED1, and V_{LED2} is a driving voltage for the second LED group LED2.

In addition, if the ripple voltage Vr is lower than Vp/2, the second diode D2 and the third diode D3 of the optical power compensation unit 11 are turned on to form a second path Path 2 and a third path Path 3. Thus, the first capacitor C1 placed on the second path and charged with Vp/2 and the second capacitor C2 placed on the third path and charged with Vp/2 are discharged in a second section T2, thereby applying the compensation voltage to the LED array 12 (Mode 2).

In the second mode (Mode 2), efficiency can be expressed as follows.

$$Efficiency ( Mode 2 ) = \frac{{V}_{P} \times 0.5}{{V}_{LED 1}} \qquad Equation 2$$

According to one embodiment of the invention, the LED driving device generates the driving current for the LED array by combination between the current directly supplied from the AC power and the current supplied from the optical power compensation unit (valley-fill circuit or the like). Therefore, as shown in Equations 1 and 2, the forward voltage of the LED groups can be designed in consideration of the efficiency of each mode.

Further, in the LED driving device according to this embodiment, the voltage charged by the first capacitor C1 and the second capacitor C2 becomes Vp/2 based on the voltage of input power, and thus the forward voltage of the first LED group 121 of the LED array 12 is set to be lower than the compensation voltage Vp/2.

In more detail, when the driving voltage based on the ripple voltage and the compensation voltage is supplied to the LED array 12, the compensation voltage is set to be higher than the sum of the forward voltage of the first LED group 121 and the voltage between both terminals (source-drain voltage, etc.) of the first switch 13.

Here, the compensation voltage can be expressed as follows.

$$\frac{{V}_{P}}{2} > {V}_{LED 1} + {V}_{SW 1} \qquad Equation 3$$

In Equation 3, Vp/2 is the compensation voltage, V_{LED1} is the forward voltage of the first LED group LED1, and V_{SW1} is voltage applied between both terminals of the first switch SW1.

In Equation 3, it can be seen that the sum of the forward voltage of the first LED group LED1 and the voltage V_{SW1} between both terminals of the first switch SW1 must be lower than a maximum level of charged voltage of the valley-fill circuit. For example, if the compensation voltage Vp/2 is 150V and the voltage V_{SW1} applied between both terminals of the first switch SW1 is 10V˜20V, the forward voltage V_{LED1} of the first LED group LED1 can be 130V˜140V. In such a case, efficiency can be schematically expressed as follows.

$$Driving Efficiency = \frac{{V}_{P} \times 0.5}{{V}_{LED 1}} \qquad Equation 4$$

That is, as shown in Equation 4, the driving efficiency becomes higher as a ratio of the compensation voltage Vp/2 output from the valley-fill circuit (i.e., the optical power compensation unit) to the LED to the forward voltage of the first LED group approaches “1”.

As such, according to the present invention, the valley-fill circuit or similar voltage compensation circuit is combined with the AC multi-stage driving technique, thereby improving a condition of optical output off-time (in which AC voltage is lower than the forward voltage of the first LED group) that is a drawback of a conventional AC LED driving technique directly using commercial AC power.

In addition, according to operating characteristics of the valley-fill circuit, energy is supplied to the LED when the input voltage is lower than Vp/2. In consideration of such characteristics, the forward voltage of the first LED group being always turned on is designed based on Equation 2, thereby providing a high efficiency driving device and a high efficiency lighting product using the same.

In this embodiment, the optical power compensation unit includes the two-stage capacitor circuit, but is not limited thereto. Alternatively, the optical power compensation unit may include a three or more-stage capacitor circuit. In this case, if the ripple voltage is higher than a value obtained by dividing the peak voltage Vp of the ripple voltage by the number of stages for the capacitor, each capacitor of the optical power compensation unit is charged with a voltage obtained by dividing the ripple voltage by the number of stages for the capacitor. On the other hand, if the ripple voltage is equal to or lower than a value obtained by dividing the peak voltage Vp of the ripple voltage by the number of stages for the capacitor, each capacitor of the optical power compensation unit discharges the charged voltage, thereby supplying the compensation voltage to the LED array 12.

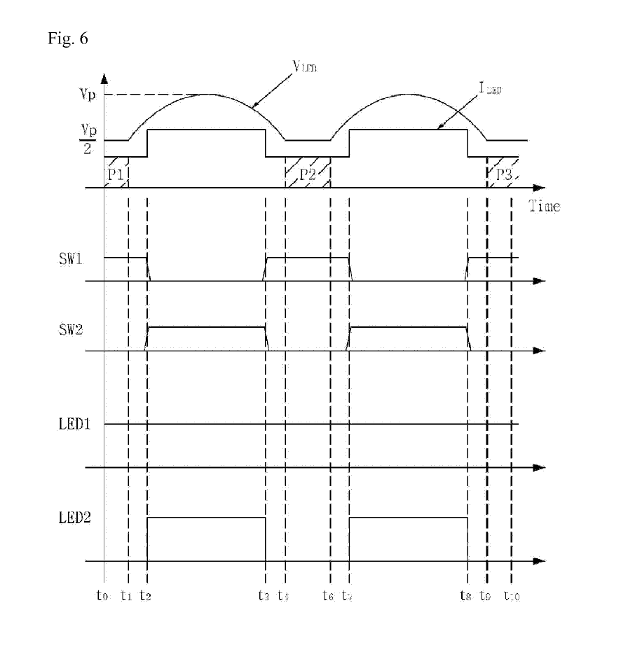

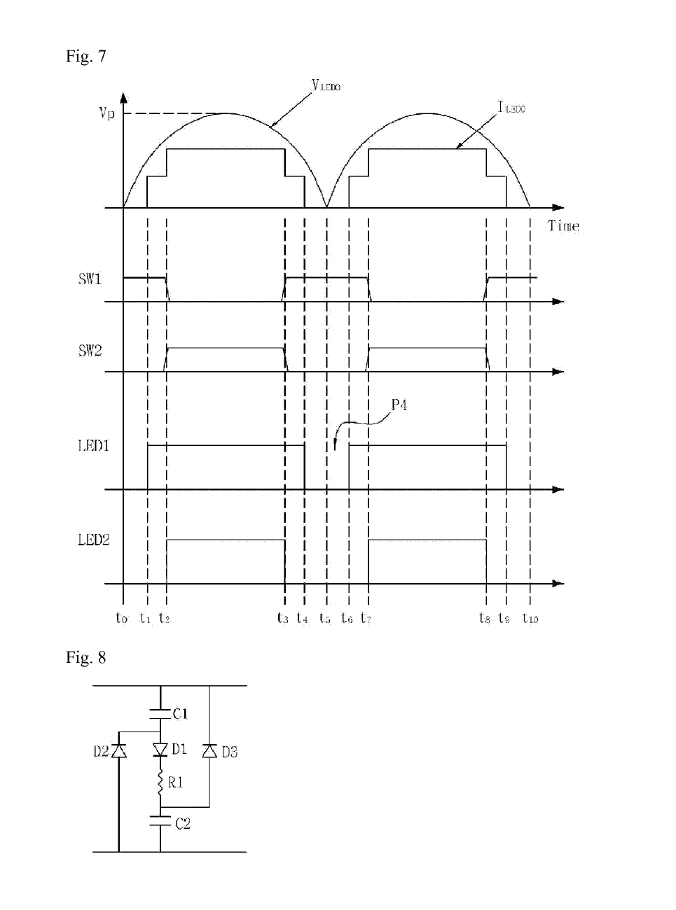

FIG. 6 is a timing view illustrating the operating principle of the optical power compensation unit in the LED driving device of FIG. 3. FIG. 7 is a timing view illustrating operation of an LED driving device according to a comparative example, which does not include the optical power compensation unit.

Referring to FIG. 6, the LED driving device according to the embodiment of the invention supplies a compensation voltage from the optical power compensation unit to the LED array such that driving voltage supplied to the LED array cannot be lower than forward voltage of the minimum number of LED devices simultaneously emitting light or forward voltage of one LED group when the ripple voltage output from the rectification unit 10 is supplied to the LED array 12 including the plurality of LED groups.

Specifically, the LED driving device supplies the LED array 12 with the driving voltage V_{LED}, i.e., the sum of the ripple voltage of the rectification unit and the compensation voltage of the optical power compensation unit. Here, as shown in FIG. 6, the driving voltage V_{LED} applied to the LED array 12 is provided in the form that sections P1, P2 and P3, in which the ripple voltage Vr from the rectification unit 10 is lower than a predetermined voltage Vp/2, are filled with the compensation voltage Vp/2 of the optical power compensation unit 11.

In this embodiment, in order to prevent a non-light-emitting section, in which all of the LED groups do not emit light due to the driving voltage that is lower than the forward voltage of the first LED group 121 at the input terminal of the LED array 12, the LED driving device charges the capacitors C1 and C2 of the optical power compensation unit 11 with the voltage Vp/2 higher than the forward voltage of the first LED group 121 of the LED array 12.

According to this embodiment, the first LED group LED1 of the LED array emits light in all of sections t₀-t₁₀ in which the first and second switches SW1, SW2 are turned on to operate the LED driving device, and the second LED group LED2 of the LED array emits light in sections t₂-t₃ and t₇-t₈ in which the second switch SW2 is turned on by turn-on operation of the second switch SW2. Thus, the LED driving device according to this embodiment can eliminate the existing non-light-emitting section through the ripple voltage and the compensation voltage when the plurality of LED groups of the LED array sequentially emit light.

In this embodiment, the first LED group LED1 emits light in the non-light-emitting section of the LED array 12 using energy (Vp/2 and the like) charged in the first capacitor C1 and the second capacitor C2 of the optical power compensation unit, without being limited thereto. Alternatively, the present invention is extendable in accordance with a connection structure of the plurality of LED groups of the LED array and the number of stages. For example, the number of stages for the capacitor of the optical power compensation unit may be increased from two to three depending upon the forward voltage of the plurality of LED groups that emit light in the non-light-emitting section. Here, n is a natural number greater than 3.

Referring to FIG. 7, an LED driving device of a comparative example supplies the driving voltage V_{LED0}, i.e. the ripple voltage, and the corresponding driving current I_{LED0} to the LED array without the compensation voltage of the optical power compensation unit. The driving voltage V_{LED0} supplied to the LED array periodically varies from OV to the peak voltage Vp. By the driving voltage V_{LED0} of the ripple voltage, the LED driving device of the comparative example has a non-light-emitting section P4 when the plurality of LED groups of the LED array are sequentially driven. Therefore, the light source, i.e., the LED array, has a section in which no light is emitted (i.e., the non-light-emitting section).

That is, in the comparative example, the first LED group LED1 and the second LED group LED2 of the LED array sequentially emit light by operation of the first switch SW1 and the second switch SW2. In addition, the non-light-emitting section P4, where both the first LED group LED1 and the second LED group LED2 do not emit light, is generated in each cycle of the driving voltage.

Next, operation of the LED array using the optical power compensation unit of the LED driving device according to the embodiment will be described with reference to FIGS. 3 and 6.

First, it is assumed that the first switch SW1 and the second switch SW2 are being short-circuited or turned on before the LED driving device operates.

If there is no optical power compensation unit, the non-light-emitting section, in which electric current does not flow in the first LED group 121 and the second LED group 122, is generated when the driving voltage V_{LED0} is lower than the forward voltage of the first LED group 121 in the LED array 12 (see t₀-t₁, t₄-t₆ and t₉-t₁₀ of FIG. 7).

However, in the LED driving device according to the present invention, the optical power compensation unit 11 supplies the compensation voltage to the LED array 12 through the second path Path 2 and the third Path 3 in certain sections P1, P2, P3 if the ripple voltage is lower than the voltage Vp/2 charged in the capacitors C1, C2 of the optical power compensation unit 11 in the certain sections (corresponding to the sections P1, P2, P3 of FIG. 6). Here, the driving voltage V_{LED} corresponds to the sum of the ripple voltage Vr and the compensation voltage. Here, the compensation voltage serves to supply the electric current of the optical power compensation unit 11 to the LED array 12 in the certain sections P1, P2, P3 when the LED array 12 is sequentially driven. To this end, the compensation voltage, that is, the voltage charged in the first capacitor C1 and the second capacitor C2, is set to be higher than the forward voltage of the first LED group 121.

If the driving voltage V_{LED} is applied to the first LED group 121 in the certain sections P1, P2, P3, the first LED group 121 is driven by operation of the first switch 13, unlike the comparative example. At this time, the switch controller 15 detects the electric current flowing in the first switch 13, and applies a control signal to the first switch 13 such that the current flowing in the first switch 13 can become a preset current.

Thus, the LED driving device according to this embodiment applies the compensation voltage of the optical power compensation unit 11 to the LED array 12 in the sections in which the ripple voltage is lower than the forward voltage of the first LED array 121, thereby preventing all of the LED groups of the LED array 12 from not simultaneously emitting light.

If the driving voltage is higher than Vp/2 and lower than the forward voltage of the first and second LED groups 121, 122 connected in series to each other in the certain sections, the capacitors C1, C2 of the optical power compensation unit 11 are charged with voltage passed through the first path Path 1 and the first LED group 121 of the LED array 12 is driven by operation of the first switch 13 with a constant current.

If the driving voltage is higher than the forward voltage of the LED array 12 in the certain sections, the capacitors C1, C2 of the optical power compensation unit 11 are charged with the ripple voltage, and the first driving switch is turned off and the second driving switch are turned on to make the first LED group 121 and the second LED group 122 emit light.

FIG. 8 is a circuit diagram of an optical power compensation unit that can be employed in an LED driving device according to one embodiment of the present invention.

Referring to FIG. 8, an optical power compensation unit according to one embodiment of the invention includes a first capacitor C1, a second capacitor C2, a first diode D1, a second diode D2, a third diode D3, and a first resistor R1. The first resistor R1 corresponds to a damping resistor.

The first capacitor C1 includes a first terminal and a second terminal, in which the first terminal is connected to an output terminal at a high potential side of the rectification unit 10 and the second terminal is connected to an anode of the first diode D1.

A cathode of the first diode D1 is connected to a first terminal of the first resistor R1. Here, the first resistor R1 includes the first terminal and the second terminal.

The second capacitor C2 includes a first terminal and a second terminal, in which the first terminal is connected to a second terminal of the first resistor, and the second terminal is connected to an output terminal at a low potential side of the rectification unit 10.

An anode of the second diode D2 is connected to the output terminal at the low potential side of the rectification unit, and a cathode of the second diode D2 is connected in common to the second terminal of the first capacitor and an anode of the first diode D1.

An anode of the third diode D3 is connected in common to the first terminal of the second capacitor C2 and the second terminal of the first resistor R1, and a cathode thereof is connected to the output terminal at the high potential side of the rectification unit 10.

According to one embodiment, the first resistor R1 is arranged between two capacitors C1 and C2, so that the capacitor of the optical power compensation unit can be prevented from being charged with overcurrent due to inrush current when the capacitor is charged, or the capacitor or the diode can be prevented from being damaged by the overcurrent.

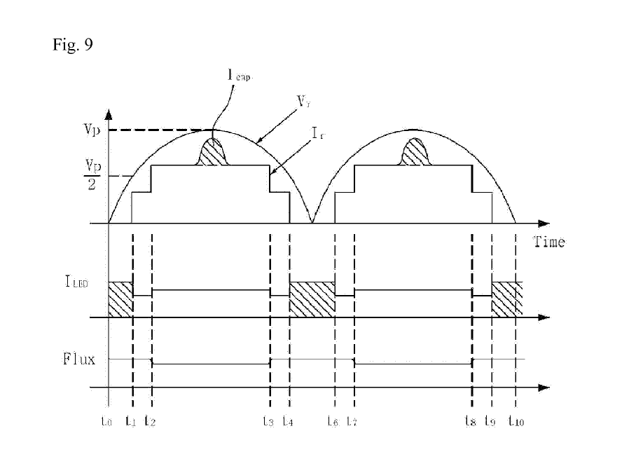

FIG. 9 is a view of waveforms for explaining operation of the optical power compensation unit in the LED driving device according to one embodiment of the invention.

Referring to FIG. 5 and FIG. 9, the LED driving device according to one embodiment supplies a ripple voltage Vr and an output current Ir from the rectification unit 10 for rectifying full waves of input AC power to the LED array 12 and the optical power compensation unit 11. The optical power compensation unit 11 charges two capacitors C1, C2 thereof in sections (schematically, t₂-t₃ and t₇-t₈), in which the ripple voltage is higher than a predetermined voltage Vp/2.

Accordingly, the LED driving device further receives electric current Icap for charging the two capacitors C1 and C2 from an external power supply (i.e. a power supply for supplying commercial AC power) in the foregoing sections. That is, in the LED driving device, the output current Ir of the rectification unit 10 is the sum of the current for sequentially driving the first and second LED groups 121, 122 of the LED array 12 and the current Icap for charging the optical power compensation unit 11.

The two capacitors C1, C2 charged with the predetermined voltage Vp/2 are discharged in sections (schematically, t₀-t₁, t₄-t₆, and t₉-t₁₀) in which the ripple voltage Vr is lower than Vp/2, thereby supplying the compensation voltage to the LED array 12.

With the aforementioned configuration, the LED driving device according to this embodiment may be set such that the driving current I_{LED} for the LED array 12 in an existing non-light-emitting section (see P4 of FIG. 7) is greater than the driving current in the other sections (t₁-t₄, t₆-t₉). Such setup serves to increase capacitance of the two capacitors C1, C2 in the optical power compensation unit 11 and to relatively narrow the section (t₄-t₆) in which the driving current is compensated by the two capacitors C1, C2.

As such, the LED driving device according to the present invention removes a non-light-emitting section of the LED array 12, and compensates optical output (Flux) in the existing non-light-emitting section, thereby increasing optical efficiency.

As described above, the LED driving device according to the present invention eliminates a non-light-emitting section through the optical power compensation unit while sequentially driving a plurality of LED groups in a light source using the ripple voltage, thereby achieving elimination of the non-light emitting section while improving power factor (PF) and suppressing total harmonic distortion (THD). In addition, the LED driving device according to the present invention directly uses the ripple voltage of the rectification unit and it is thus possible to remove an electrolytic capacitor connected to an output terminal of the existing rectification unit, thereby substantially increasing the lifespans of the LED driving device and lighting products including the LED driving device without any influence by the lifespan of the electrolytic capacitor. Further, the LED driving device according to the present invention can eliminate the relatively bulky electrolytic capacitor, thereby enabling size reduction and thin thickness of the LED driving device and products including the LED driving device.

Although some embodiments have been described herein, it should be understood by those skilled in the art that these embodiments are given by way of illustration only, and that various modifications, variations, and alterations can be made without departing from the spirit and scope of the present invention. Therefore, the scope of the invention should be limited only by the accompanying claims and equivalents thereof.

1. A light emitting diode (LED) driving device connected to an LED array comprising a LED groups and configured to sequentially drive the LED groups, the LED driving device comprising:
a rectification unit configured to rectify alternating current (AC) voltage to generate a ripple voltage;
an optical power compensation unit connected to an output terminal of the rectification unit and configured to supply a pre-stored compensation voltage to the LED array in a section in which the ripple voltage is smaller than a minimum forward voltage in the LED groups; and
a constant current drive unit connected to each of the LED groups and configured to sequentially drive each LED group with a constant current.

2. The LED driving device according to claim 1, wherein the optical power compensation unit comprises a first capacitor, a second capacitor, a first diode, a second diode, and a third diode,
the first capacitor comprising a first terminal connected to an output terminal at a high potential side of the rectification unit and a second terminal connected to an anode of the first diode,
the second capacitor comprising a first terminal connected to a cathode of the first diode and a second terminal connected to an output terminal at a low potential side of the rectification unit,
the second diode comprising an anode connected to the output terminal at the low potential side of the rectification unit and a cathode connected in common to the second terminal of the first capacitor and the anode of the first diode, and
the third diode comprising an anode connected in common to the first terminal of the second capacitor and the cathode of the first diode, and a cathode connected to the output terminal at the high potential side of the rectification unit.

3. The LED driving device according to claim 2, wherein the optical power compensation unit further comprises a resistor connected in series between the first capacitor and the second capacitor.

4. The LED driving device according to claim 2, wherein the optical power compensation unit is configured to charge each of the first and second capacitors with a voltage higher than the minimum forward voltage.

5. The LED driving device according to claim 2, wherein the rectification unit is configured to apply the ripple voltage having a peak voltage higher than the forward voltage of the LED array to the optical power compensation unit and the LED array.

6. The LED driving device according to claim 1, wherein the constant current drive unit is configured to drive at least one LED group of the LED array to continuously emit light with the compensation voltage.

7. A light emitting diode (LED) driving device, comprising:
a rectification unit configured to rectify alternating current (AC) voltage to generate a rectified voltage;
a light emitter comprising at least one light emitting diode connected to an output terminal of the rectification unit; and
an optical power compensation unit connected between the rectification unit and the light emitter and configured to supply electric current to the light emitter corresponding to a pre-stored rectified voltage in a section in which the rectified voltage is lower than a forward voltage of the light emitting diode.

8. The LED driving device according to claim 7, further comprising:
a switch unit comprising at least one switch connected to a cathode of the light emitting diode.

9. The LED driving device according to claim 8, further comprising:
a switch controller configured to detect electric current flowing in the switch and control the switch to be short-circuited or opened depending upon amplitudes of the detected electric current.

10. The LED driving device according to claim 7, wherein the optical power compensation unit is configured to perform charging with a constant voltage in a section in which the rectified voltage is higher than or equal to a preset first voltage, and to discharge the charged voltage in a section in which the rectified voltage is lower than the first voltage.

11. The LED driving device according to claim 7, wherein the optical power compensation unit comprises:
a first capacitor and a second capacitor connected in series between an output terminal at a high potential side of the rectification unit and an output terminal at a low potential side of the rectification unit;
a first diode forward connected between the first capacitor and the second capacitor;
a second diode comprising a cathode connected to the first capacitor and an anode connected to the output terminal at the low potential side of the rectification unit, and
a third diode comprising an anode connected to a connection node between the first diode and the second capacitor, and a cathode connected to the output terminal at the high potential side of the rectification unit.

12. The LED driving device according to claim 11, wherein the first capacitor and the second capacitor are configured to be charged with a voltage obtained by dividing a peak voltage of the rectified voltage by a number of stages for the capacitor.

13. The LED driving device according to claim 11, wherein the optical power compensation unit is configured to charge the first capacitor and the second capacitor with voltage when the rectified voltage is higher than or equal to the first voltage determined by a number of stages for the capacitor involved in the optical power compensation unit, and configured to discharge the voltage charged in the first and second capacitors to the light emitter when driving voltage is lower than the first voltage.

14. The LED driving device according to claim 11, wherein the optical power compensation unit further comprises a resistor comprising one end connected to the cathode of the second diode, and the other end connected to a connection node between the second capacitor and the third diode.

15. The LED driving device according to claim 11, wherein the first voltage is higher than the forward voltage of the light emitting diode.

16. The LED driving device according to claim 12, wherein the first voltage is higher than the forward voltage of the light emitting diode.

17. The LED driving device according to claim 13, wherein the first voltage is higher than the forward voltage of the light emitting diode.

18. The LED driving device according to claim 14, wherein the first voltage is higher than the forward voltage of the light emitting diode.

19. A method of driving a light emitting diode (LED) device, the method comprising:
receiving an alternating current (AC) voltage;
rectifying the AC voltage to generate a rectified voltage;
pre-storing the rectified voltage;
supplying electric current to an LED corresponding to the rectified voltage in a section in which the rectified voltage is equal to or greater than a forward voltage of the LED; and
supplying electric current to the LED corresponding to the pre-stored rectified voltage in a section in which the rectified voltage is lower than the forward voltage of the LED.

20. The method of claim 19, wherein pre-storing the rectified voltage comprises:
charging a first capacitor and a second capacitor connected in series with a voltage when the rectified voltage is higher than or equal to a first voltage determined by a number of stages of capacitors; and
discharging the voltage charged in the first and second capacitors to the LED when driving voltage is lower than the first voltage.
